(19) United States
(12) Patent Application Publication
(10) Pub. No.: US 2004/0210736 A1
(43) Pub. Date: Oct. 21, 2004

(54) Method and apparatus for the allocation of identifiers

(76) Inventors: Linden Minnick, Portland, OR (US); Miles J. Penner, Portland, OR (US)

Correspondence Address: INTEL CORPORATION, P.O. BOX 5326, SANTA CLARA, CA, 95056-5326, US

(21) Appl. No.: 10/419,014

(22) Filed: Apr. 18, 2003

(51) Int. Cl. G06F 12/00

(52) U.S. Cl. 711/216; 711/210; 711/170

(57) ABSTRACT

A method and apparatus for the allocation of memory identifiers is generally described. In accordance with one example embodiment of the invention, a method of allocating identifiers comprising generating a hash value associated with a proposed identifier and allocating the identifier only if the hash value has not yet been used in association with another identifier.

### TECHNICAL FIELD

Embodiments of the present invention generally relate to the field of electronic systems, and more particularly, to a method and apparatus for the allocation of identifiers, e.g., for use with memory systems

### BACKGROUND

The use of a hash table, which maps memory locations to associated hash values is well known. Those skilled in the art will appreciate that when using a hash table for memory allocation, collisions (where two physical addresses in memory are mapped to the same hash value) might occur. These collisions, when associated with memory allocation, typically require complicated data structures to manage. These complicated data structures are more likely to require debugging as problems associated with such collisions may arise during initialization or run-time of the host device. This is problematic since the debugging required to alleviate the possibility of such collisions is difficult and time consuming, especially when the memory allocation mechanism occurs in a device driver.

### BRIEF DESCRIPTION OF THE DRAWINGS

The present invention is illustrated by way of example, and not by way of limitation, in the figures of the accompanying drawings in which like reference numerals refer to similar elements and in which:

FIG. 1 is a block diagram of an electronic system incorporating the teachings of the present invention, according to but one example embodiment of the invention;

FIG. 2 is an architectural diagram of a driver agent, according to one example embodiment of the present invention;

FIG. 3 is a flow chart of an example method of memory allocation in accordance with the teachings of the present invention, according to one example embodiment; and

FIG. 4 is a graphical illustration of memory element(s) during memory allocation in accordance with the teachings of the present invention, according to but one example embodiment.

### DETAILED DESCRIPTION

Methods and apparatus for the allocation of identifiers are generally described. In particular, to identify and allocate identifiers, e.g., associated with memory elements, that will not cause collisions, e.g., during initialization or runtime of a host device. In accordance with but one example embodiment, a method to ensure selection of identifiers (e.g., associated with memory elements) without possibility of collision is presented comprising generating a hash value associated with a proposed identifier, and allocating the proposed identifier only if the hash value has not yet been used in association with another identifier.

In one example embodiment, allocation of such unique identifiers may occur during the initialization of a host device and/or dynamically during the run-time of a host device. By only using allocated identifiers that have not yet collided with other memory elements, the present invention eliminates the possibility of collision. This allows much simpler data structures to be used, reducing the complexity significantly.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment. Likewise, the appearances of the phrase “in another embodiment,” or “in an alternate embodiment” appearing in various places throughout the specification are not all necessarily all referring to the same embodiment.

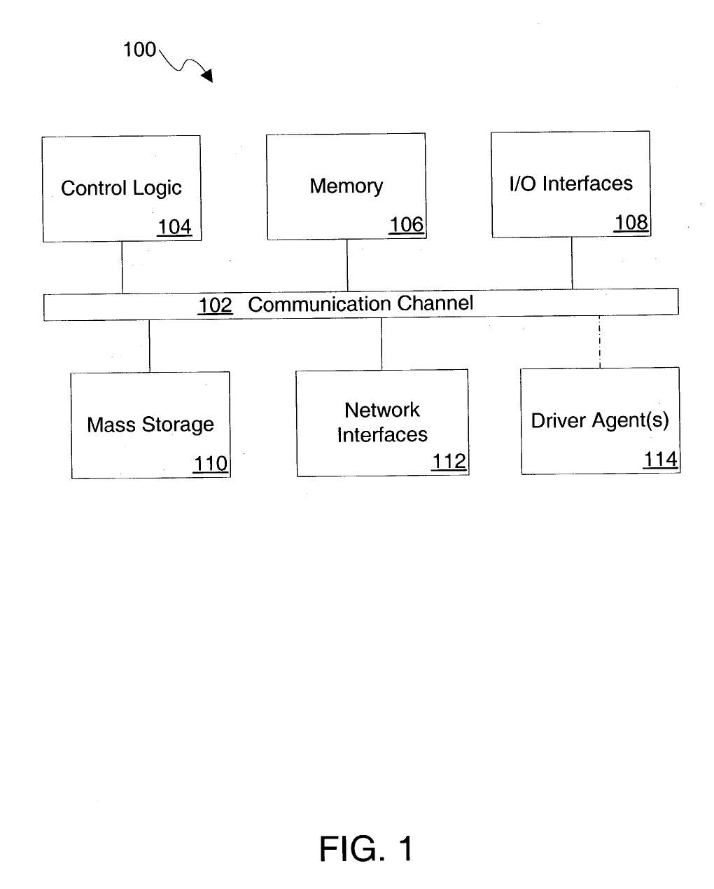

FIG. 1 is a block diagram of an electronic system 100 incorporating the teachings of the present invention, according to but one example embodiment. Electronic system 100 may be, for example, a computer, a Personal Digital Assistant (PDA), a set-top box, a communications device (e.g., cellular telephone, wireless communicator, etc.), or any other electronic system.

In accordance with the illustrated example implementation of FIG. 1, electronic system 100 is depicted comprising communication channel 102, control logic 104, memory 106, input/output (I/O) interfaces 108, mass storage 110, network interfaces 112 and driver agent(s) 114, each logically coupled as depicted.

In accordance with one example embodiment of the present invention, control logic 104 may process information and execute instructions to implement the various functions/features offered by electronic system 100. Electronic system 100 further includes memory 106 to store information and instructions to be executed by control logic 104 in support of the functions/features offered by electronic system 100. In this regard, memory 106 may also be used to store temporary variables or other intermediate information during execution of instructions by control logic 104. As used herein, memory 106 may well include one or more of random access memory (RAM), read-only memory (ROM), flash, or other static or dynamic storage media.

I/O interfaces 108 enables one or more element(s), e.g., control logic 102 to interact with input and/or output devices. For example, input devices such as a mouse, keyboard, touchpad, etc. and/or output devices (e.g., cathode ray tube monitor, liquid crystal display, etc.).

Mass storage 110 is intended to represent any of a number of storage media known in the art including, but not limited to, for example, a magnetic disk or optical disc and its corresponding drive, a memory card, or another device capable of storing machine-readable instructions.

Network interfaces 112 couple electronic system 100 to other electronic systems over a network. As used herein, network interface 112 is intended to represent any of a number of hardware and/or software elements(s) to facilitate communication between electronic system 100 and one or more communicatively coupled network(s) (not particularly denoted). In this regard, according to one example implementation, network interface 112 may well comprise one or more of an Ethernet interface, a SONET interface, a wireless communication interface, and the like.

In one embodiment, network traffic streams are transmitted and/or received by system 100 through network interfaces 112. Operations are performed on network traffic before transmitting and/or receiving. These operations can be performed by network interfaces 112. To perform these operations driver agent(s) 114 may direct network interfaces 112 to portions of memory 106 which are available for use in these operations. The portions of memory 106 are addressed with a unique physical address, which may be devoted to a memory identifier. In one example embodiment the portions of memory 106 may be utilized as a form of host buffer memory.

As introduced above, and developed more fully below, driver agent(s) 114 dynamically allocates unique identifiers, e.g., for use in memory mapping functions of, e.g., electronic system 100. According to one example implementation, control logic 104 may invoke an instance of driver agent(s) 114 to map specific portions of memory 106 available for use by system 100. Driver agent(s) 114 may then direct network interfaces 112 to the memory identifiers allocated by driver agent(s) 114 for use by network interfaces 112. In this regard, each time network interfaces 112 requires portions of memory 106 to perform operations on network traffic, driver agent(s) 114 directs network interfaces 112 to those specific memory identifiers.

According to one example embodiment, the dynamic allocation of unique identifiers by driver agent(s) 114 may well be implemented in hardware, software, firmware, or any combination thereof e.g., coupled to system 100, as shown. In this regard, driver agent(s) 114 may well be implemented as one or more of an Application Specific Integrated Circuit (ASIC), a special function controller or processor, a Field Programmable Gate Array (FPGA), or other hardware device, firmware or software to perform at least the functions described herein. Although depicted as an integral element of system 100 in FIG. 1, those skilled in the art will appreciate, based on the disclosure herein, that driver agent(s) 114 may well be implemented remotely from, yet associated with, system 100 to provide system 100 with at least the driver features described herein. Such alternate implementations are anticipated by the scope and spirit of the present invention.

Machine-readable instructions can be provided to memory 106 from a form of machine-accessible medium. As used herein, a machine-accessible medium is intended to represent any mechanism that provides (i.e., stores and/or transmits) information in a form readable by a machine (e.g., a electronic system 100). For example, a machine-accessible medium may well include read only memory (ROM); random access memory (RAM); magnetic disk storage media; optical storage media; flash memory devices; electrical, optical, acoustical or other form of propagated signals (e.g., carrier waves, infrared signals, digital signals); and the like. Instructions may also be provided to memory 106 via a remote connection (e.g., over a network).

In alternative embodiments, hard-wired circuitry can be used in place of or in combination with software instructions to enable system 100 to allocate memory identifiers utilizing a driver agent(s) 114 as introduced above, and developed more fully below. Thus, the electronic system depicted above is not limited to any specific combination of hardware 100 circuitry and software structure.

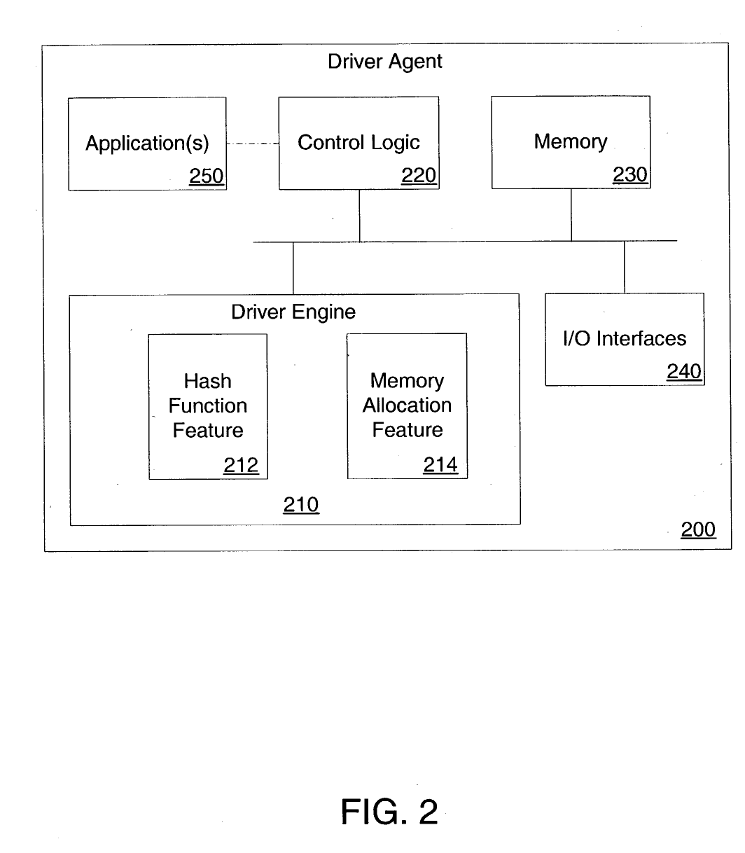

FIG. 2 is an architectural diagram of an example driver agent, according to but one example embodiment of the present invention. In accordance with the illustrated example implementation of FIG. 2, driver agent 200 is depicted comprising one or more of a driver engine 210, control logic 220, memory 230, I/O interfaces 240, and optionally, one or more application(s) 250, each logically coupled as depicted. Although depicted as a number of disparate functional elements, those skilled in the art will appreciate from the disclosure herein, that driver agents of greater or lesser complexity that nonetheless perform the functions/features described herein, whether implemented in hardware, software, firmware or a combination thereof, are anticipated within the scope and spirit of the present invention.

In accordance with one example embodiment of the present invention, driver engine 210 is depicted comprising one or more of a hash function feature 212 and memory allocation feature 214. As introduced above, and developed more fully below, hash function feature 212 and memory allocation feature 214 of driver engine 210 selectively allocate unique memory identifiers to prevent and/or eliminate the potential for collisions to occur.

As used herein, control logic 220 may control the overall operation of driver agent 200. According to one example embodiment, control logic 220 may selectively invoke an instance of driver engine 210 to generate and selectively allocate identifiers to element(s) of memory for use by a host system (e.g., electronic system 100). More particularly, according to one example implementation, driver engine 210 invokes an instance of hash function feature 212 to hash potential memory identifiers for use by driver agent 200. Moreover, when driver agent 200 receives available memory identifiers (e.g. from host memory), control logic 220 may invoke an instance of driver engine 210 to selectively allocate those memory identifiers in a way which guarantees no collisions.

As used herein, control logic 220 is intended to represent any of a wide variety of logic device(s) and/or content which coordinates the overall operation of driver agent 200. In this regard, control logic 220 may well be comprised of a microprocessor, microcontroller, field-programmable gate array (FPGA), application specific integrated circuit (ASIC), executable content to implement such control features and/or any combination thereof. In alternate embodiments, the features and functionality of control logic 220 may well be implemented within driver engine 210.

As used herein, memory 230 is similarly intended to represent a wide variety of memory media including, but not limited to, volatile memory, non-volatile memory and programmatic variables or states. According to one example implementation, memory 230 is used by driver agent 200 to temporarily store a hash table, e.g., generated by hash function 212. In this regard, memory 230 may well include a hash table with one or more entries for placing hashed values generated by hash function feature 212 and associated with memory identifiers available for allocation.

As used herein, I/O interfaces 240 provide a communications interface between driver agent 200 and an electronic system. For example, driver agent 200 may be implemented as an element of a computer system, wherein I/O interfaces 240 provide a communications interface between driver agent 200 and the computer system via a communication channel. In this regard, control logic 220 can receive a series of instructions from application software external to driver agent 200 via I/O interface(s) 240.

It should be appreciated that driver agent 200 need not be integrated within an electronic system for the electronic system to access and benefit from the features of driver agent 200 described herein. That is, as introduced above, I/O interfaces 240 may provide a communications interface between driver agent 200 and an electronic system through, e.g., a network communication channel, enabling the remote electronic system to access and employ the features of driver agent 200.

In an example embodiment, driver agent 200 may include one or more applications 250 to provide internal instructions to control logic 220. As used herein, such application(s) may well be invoked to generate a user interface, e.g., a graphical user interface (GUI), to enable administrative features, and the like. In alternate embodiments, one or more features of driver engine 210 may well be implemented as a software application 250, selectively invoked by control logic 220 to invoke such features. To the extent that they are not used to implement one or more features of the present invention, applications 250 are not necessary to the function of driver agent 200.

According to one example embodiment, portions of memory 106 of electronic system 100 are addressed and accessed through the use of memory identifiers. As introduced above, driver agent 200 selectively allocates portions of memory 106 for use by network interfaces 112. In this regard, driver agent 200 selectively invokes an instance of hash function feature 212 to hash a value associated with a proposed memory identifier into a temporary hash table, e.g., maintained in memory 230. The temporary hash table in memory 230 should be large enough to allow for allocation of all memory identifiers available to driver agent 200.

Memory allocation feature 214 then determines if a hash value associated with another proposed memory identifier has hashed to the same entry in the temporary hash table. If no preceding value associated with another memory identifier has hashed to the same entry, that physical address is then allocated for use as mentioned previously. If a preceding value does hash to the same entry, then a collision has occurred. This proposed physical address will not be used.

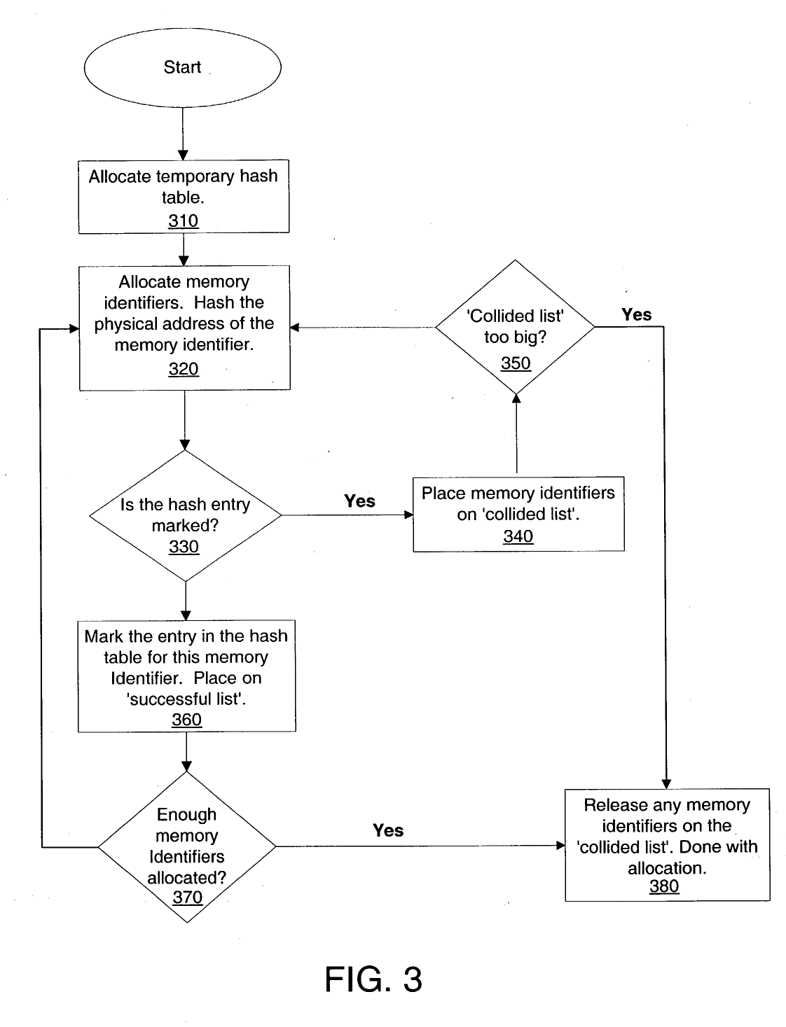

FIG. 3 is a flow chart of an example method of memory allocation in accordance with the teachings of the present invention, according to one example embodiment. In the illustrated example embodiment of FIG. 3, the process begins with block 310 wherein control logic 220 invokes an instance of driver engine 210. According to one example implementation, in response to control logic 220, driver engine 210 selective invokes an instance of hash function feature 212. As introduced above, hash function feature 212 selectively generates a temporary hash table in memory 230 to accommodate at least the number of memory identifiers available for allocation. Once a temporary hash table is generated, block 310, the process moves to block 320 where hash function feature 212 generates a hash value associated with a proposed memory identifier for selective allocation to the temporary hash table in memory 230.

In block 330, driver engine 210 invokes an instance of memory allocation feature 214. As introduced above, memory allocation feature 214 determines whether a hash entry generated in block 320 has already been allocated, e.g., representing a previously allocated memory identifier. As presented above, if the hash value has already been used to represent another memory location, allocation of the hash to the proposed memory location may well result in collisions. Thus, if a proposed hash value has hashed to a previously allocated location in the temporary hash table, memory allocation feature 214 records the particular memory identifier on a “collided list”, e.g., maintained in memory 230, block 340.

Moving to block 350, memory allocation feature 214 determines if an unacceptable number of collided identifiers are on the “collided list.” If so, the process continues with block 380, wherein memory allocation feature 214 release(s) at least a subset of the memory identifiers on the “collided list” and allocation is done. Alternatively, from block 350, the process continues with block 320 wherein a hash value is generated for the next proposed memory identifier.

As the process returns back to block 330, if memory allocation feature 214 determines that the hash value created in block 320 has not previously been used (e.g., as represented in the temporary hash table), memory allocation feature 214 promotes the hash value to an open location within the temporary hash table in memory 230, block 360. According to one example implementation, memory allocation feature 214 may place the memory identifier on a “successful list” also maintained in memory 230. In accordance with this example implementation, the “successful list” is a list of memory identifiers, which will be mapped by driver agent 200 as available for allocation and guaranteed to have no collisions.

Continuing on to block 370, memory allocation feature 214 may determine if an acceptable number of memory identifiers are allocated in the “successful list” maintained in memory 230. If so, the process continues to block 380 wherein memory allocation feature 214 releases at least a subset of memory identifiers on the “collided list”. If not, then the process moves to block 320 and allocation continues as described above.

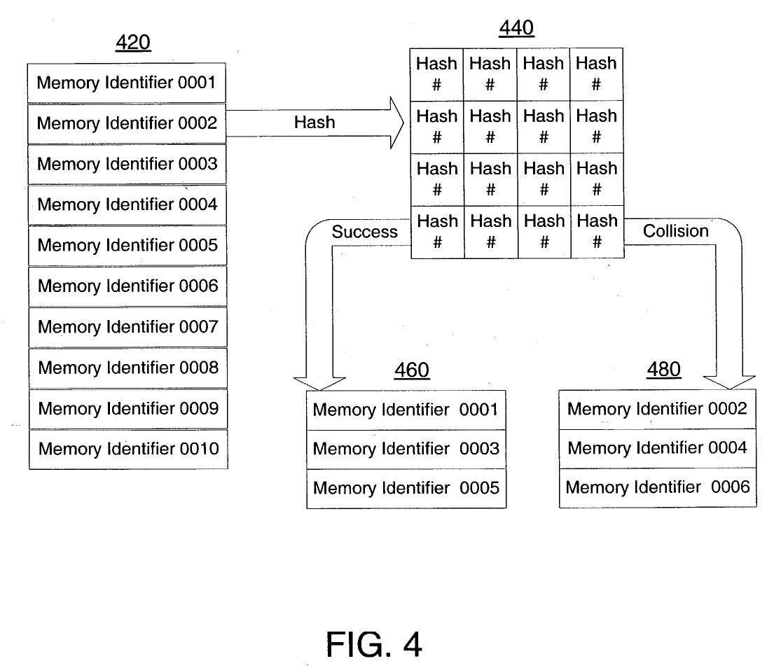

FIG. 4 is a graphical illustration of the example method of memory allocation introduced is in FIG. 3. That is, FIG. 4 graphically illustrates memory element(s) during memory allocation in accordance with the teachings of the present invention, according to but one example embodiment. As shown, memory identifiers 420 are hashed to temporary hash table 440. If no preceding memory identifier has hashed to the same location in temporary hash table 440, that location in the table is marked and the memory identifier is placed on “successful list” 460.

Alternatively, if the hash value hashes to a previously allocated location in the temporary hash table, a potential for a collision would arise by allocation of this subsequent hash value. Thus, in accordance with the teachings of the present invention, to mitigate the risk of such collisions, this subsequent memory identifier is placed on “collided list” 480. Once a number of either unacceptable collisions or acceptable successes is reached, memory allocation is done.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative of, rather than limiting the scope and coverage of the claims appended hereto.

What is claimed is:

1. A method of allocating identifiers comprising:
generating a hash value associated with a proposed identifier; and
using the identifier only if the hash value has not yet been used in association with another identifier.

2. A method according to claim 1, wherein the identifiers are physical addresses of a host buffer memory.

3. A method according to claim 1, wherein the element of allocating the identifier comprises:
allocating the identifier for use by a host device.

4. A method according to claim 3, wherein the host device is network interface card.

5. A method according to claim 1, wherein the element of allocation is performed during an initialization of the host device.

6. A method according to claim 1, wherein the element of allocation is performed during a run-time of a host device:

7. A method of allocating identifiers associated with a physical address of memory comprising:
generating a hash value associated with an identifier; and
selectively using the identifier based, at least in part, on whether a hash of the identifier results in a collision with a previously allocated identifier.

8. A method according to claim 7, wherein the identifier is a physical address of a host buffer memory.

9. A method according to claim 7, wherein the element of allocating the identifier comprises:
allocating the identifier for use by a host device.

10. A method according to claim 9, wherein the host device is network interface card.

11. An apparatus comprising:
a memory including an identifier associated with a physical address; and
a driver agent, coupled with the memory, to selectively use the identifier based, at least in part, on whether a hash of the identifier results in a collision with a previously allocated identifier.

12. An apparatus according to claim 11, wherein the memory is a buffer in a host device.

13. An apparatus according to claim 12, wherein the host device is network interface card.

14. An apparatus according to claim 11, wherein the driver agent allocates the identifier during an initialization of the host device.

15. An apparatus according to claim 11, wherein the driver agent dynamically allocates the identifier during a run-time of the host device.

16. A driver agent comprising:
a memory including a hash table; and
a driver engine, coupled with the memory, to selectively allocate an identifier associated with a physical address of memory based, at least in part, on whether a hash of the identifier already exists in the hash table.

17. A driver agent according to claim 16 wherein, the physical address of memory is the physical address to buffer memory to a host device.

18. A driver agent according to claim 17, wherein the host device is a network interface card.

19. A driver agent according to claim 16, wherein the driver engine allocates the identifier during an initialization of a host device.

20. A driver agent according to claim 16, wherein the driver engine dynamically allocates the identifier during a run-time of a host device.

21. A system comprising:
volatile memory including memory elements, each memory element denoted by an identifier; and
a driver agent, coupled with the volatile memory, to selectively allocate the identifier based, at least in part, on whether a hash of the identifier results in a collision with a previously allocated identifier.

22. A system according to claim 21, wherein the identifier is associated with a physical address to buffer memory to a host device.

23. A system according to claim 22, wherein the host device is a network interface card.

24. A storage medium comprising content, which, when executed by a machine, causes the machine to:
generate a hash value associated with an identifier; and
use the identifier only if the hash value has not yet been used in association with another identifier.

25. A storage medium according to claim 24, wherein the identifier is a physical address of host buffer memory for a host device.

26. A storage medium according to claim 25, wherein the host device is a network interface card.

27. A storage medium according to claim 24, wherein the machine allocates the identifier during an initialization of a host device.

28. A storage medium according to claim 24, wherein the machine dynamically allocates the identifier during a run-time of a host device.
